(19) United States
(12) Patent Application Publication
(10) Pub. No.: US 2024/0109447 A1
(43) Pub. Date: Apr. 4, 2024

(54) PORTABLE EXTREMELY FAST CHARGER FOR OFF-ROAD ELECTRIC VEHICLES

(71) Applicant: Drexel University, Philadelphia, PA (US)

(72) Inventors: Fei Lu, Wynnewood, PA (US); Hua Zhang, Philadelphia, PA (US); Yao Wang, Philadelphia, PA (US); Shuyan Zhao, Philadelphia, PA (US); Reza Kheirollahi, Philadelphia, PA (US)

(73) Assignee: Drexel University, Philadelphia, PA (US)

(21) Appl. No.: 18/479,878

(22) Filed: Oct. 3, 2023

Related U.S. Application Data
(60) Provisional application No. 63/378,333, filed on Oct. 4, 2022.

(51) Int. Cl. B60L 53/51; B60L 53/30; B60L 53/53; B60L 53/62

(52) U.S. Cl. CPC B60L 53/51; B60L 53/305; B60L 53/53; B60L 53/62

(57) ABSTRACT

An integrated portable extremely fast charger (XFC) may be installed for heavy-duty off-road vehicles, such as tractors and combine harvesters. The XFC shortens the charging period of plug-in hybrid electric vehicles (PHEVs) and battery electric vehicles (BEVs) by providing >500 kW in a single charger. The proposed XFC integrates a solar farm and local energy storage system (ESS) such that the local grid only needs to provide the power gap between the vehicle battery and the local ESS during charging events, yielding a low-cost XFC installation and higher renewable energy penetration. Two design approaches for the XFC, conductive and wireless, are based on multiphase interleaved dc-dc converter circuit, permitting flexible access to electricity. Smart fault protection mechanism is also proposed to achieve high safety during charging events. The hexagonal prism charger may be integrated into the power electronic devices with a transformer, yielding a high compactness and power density.

### BACKGROUND

DC extreme fast charging (XFC) is an emerging technology for rapid EV charging with 350 kW or more. And electric vehicles are becoming more prevalent, even for offroad activities. Offroad sites, however, may be far from traditional charging stations. There exists a need in this context for an off-road charger, and in particular, one that can quickly charge a vehicle so it is ready for travel.

### SUMMARY OF THE EMBODIMENTS

This disclosure relates to a portable extremely fast charger used in battery charging. In particular, a conductive fast charging system that includes an integrated power source including a power grid, a solar farm, and energy storage system; fault protection connected to the integrated power source wherein the fault protection is based on multiple mutually coordinated solid-state DC circuit breakers; and an off vehicle portable charger connected to the fault protection and coordinated therewith, wherein the off vehicle portable charger comprises at least one multiphase interleaved circuit that reduces the ripples of charging currents and filter size, wherein the interleaved circuit is in a modular hexagonal prism configuration that integrates power electronic devices with transformers.

### BRIEF DESCRIPTION OF THE DRAWINGS

FIG. 1 shows a system structure of 500 kW conductive Extremely Fast Charger (XFC).

FIGS. 2(a)-(e) show hexagonal prism configurations of the 500 kW conductive XFC.

FIG. 3 shows a system structure of 500 kW wireless XFC.

FIGS. 4(a)-(d) show configurations of the 500 kW wireless XFC.

### DETAILED DESCRIPTION OF THE EMBODIMENTS

Approach #1: 500 kW Conductive Extremely Fast Charger

FIG. 1 shows the conductive 500 kW extremely fast charger (XFC) system structure 100. The XFC structure includes an integrated power source 110, fault protection 120, off-vehicle portable charger 130, and off-road vehicles 140 that engage with the system 100.

The integrated power structure 110 may include an AC power grid 112 connected to a PFC (Power Factor Correction) rectifier 113 that improves the power factor of an electrical load from the AC power grid 112.

The power source 110 may integrate the grid 112 with a solar farm 114 and energy storage system 116, relieving the power burden of the local AC grid 112. A solar farm 114 is ideal for off-road charging locations and may be connected to a Maximum Power Point Tracking (MPPT) converter 115, which is a technology used in photovoltaic solar systems to optimize the power output from solar panels, which is essentially a type of DC to DC converter that adjusts the electrical operating point of the modules or array of modules such that they deliver the maximum available power to the load (typically, to the batteries in an energy storage system 116).

The energy storage system 116 may be connected to a bidirectional DC-DC converter 117 that can transfer electrical energy bidirectionally between two DC sources. The fault protection 120 may include multiple mutually coordinated solid-state DC circuit breakers 122, which guarantees high safety during charging events. Three breakers 122 are connected to each of the PFC rectifier 113, MPPT converter 115, and bidirectional dc-dc converter 117, and also an 800V CD converter 124. The remaining solid state circuit breakers 124 are connected to 500 kW multiphase interleaved converters 132 (two are shown but of course more are possible, and 500 kW converters are shown but not limiting) within the off-vehicle portable charger 130.

Vehicles 140 may engage the portable charger 130 to receive charging, via a cable (not shown) with a charging plug appropriate to mate with the vehicle 140. The vehicles may be configured in different ways but normally, at least include a battery management system 142 that manages power transfer, regulation, and charging, a battery 144, and a motor 146. Each vehicle (FIG. 1 shows 2 vehicles) is connected to each 500 kW multiphase interleaved converter 132 via a power cable for charging.

A central control 150 monitors, controls, and protects the XFC system structure 100. The central control may be integrated with the XFC system structure system 100, or it may be remote from it, and it may be wired or wirelessly connected thereto. As indicated by the arrows in FIG. 1, the central control 150 is in communication with the integrated power source 110, fault protection 120, portable charger 130, and each vehicle 140. The vehicle can provide access and charging feeback regarding the vehicle 140. The integrated power source 110 can provide real-time electrical parameters to the central control 150.

The central control shares and monitors generated energy between the AC grid 112, the solar panels/farm 114, and energy storage system 116. At different times and for different reasons to maximize efficiency, any or all of them may be providing power through the converters 130 to the vehicles 140. The central control 150 provides grid frequency regulation to ensure maximum charging efficiency.

The control system further assists in voltage regulation, corrects power factor, and schedules reactive power demand, and finally, mitigates power outages. Non-limiting examples of how the control system 150 may perform these tasks are as follow:
Assist in Voltage Regulation: Distributed Control: Advanced EV charging control systems can monitor the local grid voltage and adjust the charging rate dynamically to maintain the desired voltage levels. Coordinated Charging: By coordinating the charging of multiple vehicles 140, the control system 150 can avoid simultaneous high demand, which might lead to voltage dips. Demand Response: The system can be integrated into wider demand response networks where grid operators signal charging infrastructure to increase or decrease demand based on real-time grid conditions, helping maintain consistent voltage levels.
Correct Power Factor: Power Factor Correction (PFC) Equipment: The system can integrate PFC circuitry to adjust the phase difference between current and voltage, thus improving the power factor. Reactive Power Compensation: The system may be designed to handle both active (real) and reactive power. By injecting or absorbing reactive power as needed, the chargers can support the grid in maintaining a near-unity power factor.
Schedule Reactive Power Demand: Predictive Analytics: By analyzing past charging data, grid conditions, and usage patterns, the system can predict reactive power demand and adjust its operation accordingly. Integration with Energy Management Systems: By interfacing with broader energy management systems or grid operator signals, the EV charging control system can be informed of times when reactive power support is most needed and adjust its operation to provide such support.
Mitigate Power Outages: Load Shedding: During impending overload situations that can lead to outages, the control system can proactively reduce or halt charging operations to decrease the load on the grid. Grid Health Monitoring: The system can monitor grid health indicators and reduce charging demand if any anomalies or precursors to outages are detected. Integration with Microgrids and Storage: In areas with microgrids or localized energy storage solutions, the system can draw power from these sources during grid instabilities or outages, ensuring continued charging while relieving stress on the main grid.

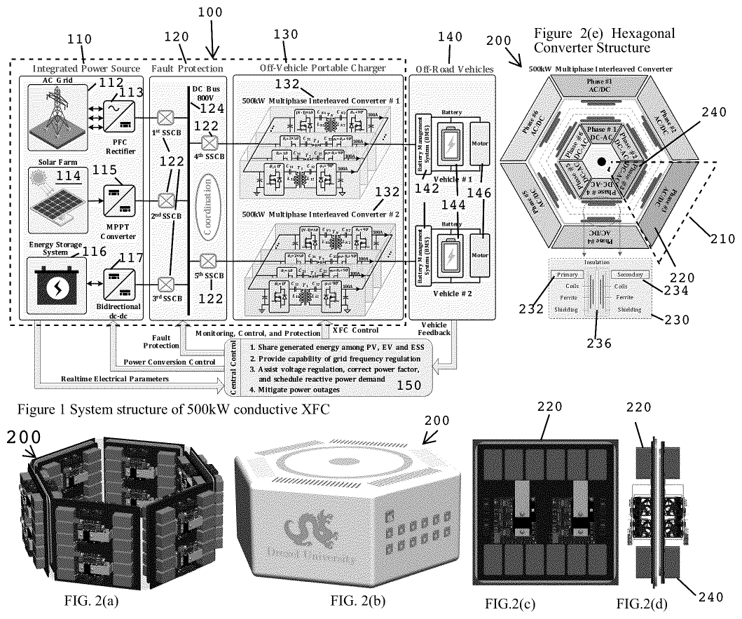

A Multiphase interleaved XFC circuit is proposed, which significantly reduces the ripples of charging currents and filter size. The proposed conductive XFC is designed in a modular hexagonal prism configuration, clearly seen in FIGS. 2(a)-2(e), which integrates all the power electronic devices with transformers, yielding a compact charger and high power density. FIG. 2(e) shows a top down view through the portable XFC 200, and FIGS. 2(a)-2(b) show other views of the XFC and its components, including a housing in FIG. 2(b).

Specifically, FIGS. 2(a)-2(e) show the hexagonal prism configuration of the portable XFC 200, corresponding to the converter 132 from FIG. 1. The hexagonal converter 200 includes six sub-converters 210 labeled as Phase 1-6 that are interleaved by a phase angle of 30-degrees. Note that in FIG. 2, only the phase 3 subconverter 210 is labeled with the reference number “210” for simplicity. Each sub-converter 210 may include three components: a primary side converter 220, a planner transformer 230, and a secondary side converter 240. The primary side converter 220 is integrated with the planar transformer 230's primary side 232. The second side converter 240 is integrated with the planar transformer 230's secondary side 234. Each side 232, 234 may include shielding, ferrite, and coils as shown and the insulation 236 between the primary and secondary sides 232, 236 of the planar transfer insulates these components from one another.

The multiphase transformers 230 are distributed on the side faces of the hexagonal converter 200 and the input (DC-AC) is connected inside while the output (AC-DC) is connected outside. The power electronic devices are integrated with transformers, enabling high compactness, modularity, and high power density. Meantime, the proposed XFC design is scalable and can be flexibly extended to other shapes like an octagonal prism, etc. as design parameters would require.

As should be apparent, there are multiple phases in the proposed interleaved structure. From a hardware perspective, each phase is identical. The only difference is the controlled phase angle for the primary side inverter. There is a phase shift between each phase. The output side of each phase are connected together. This can help to eliminate the output side filter and reduce the system size, providing the compact arrangement shown in FIGS. 2(b)-2(e).

Approach #2: 500 kW Wireless Extremely Fast Charger

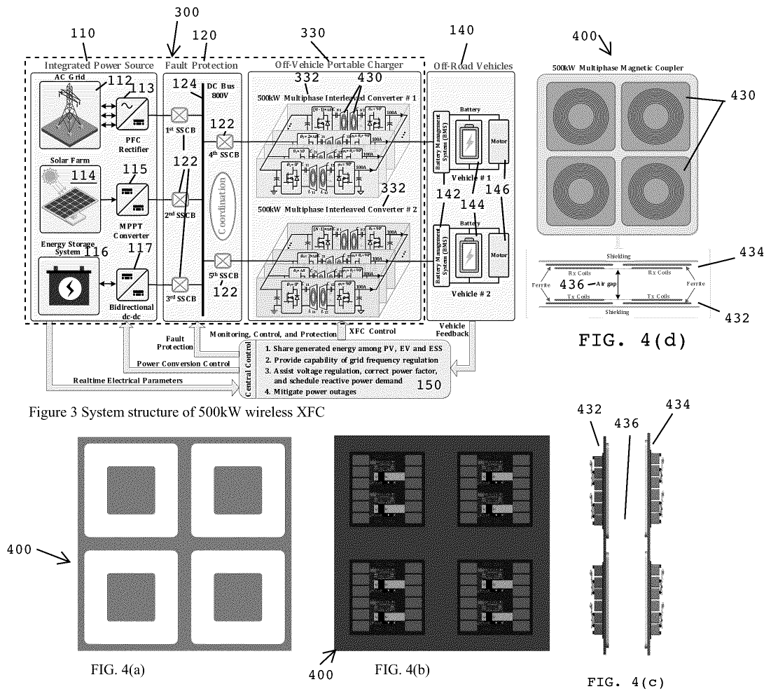

FIG. 3 shows the system structure of the 500 kW wireless XFC 300. The integrated power source 110, fault protection 120, and control system 150 include the same components and share the same architecture as already discussed and are not repeated here. The off-vehicle portable charger 330, however, may include loosely coupled magnetic couplers 430 in place of the transformers 230.

FIG. 4(d) shows an air gap 436 between the transmitter 432 and receiver 434 of the magnetic coupler 430 and the alternating magnetic field therebetween achieves transfer power. The proposed multiphase interleaved circuits 332 enable high charging power with minimized ripples of charging current Both the transmitter 432 and receiver 434 include coils, ferrite, and shielding. The receiver 434 may be installed on the chassis of the vehicles 140 and the transmitter 432 can be portable or installed on the ground surface.

FIGS. 4(a)-4(d) show other possible details of the configuration of the transmitter/receiver. The coils can be rectangular or circular. Ferrite may be used to enhance the coupling between transmitter 432 and receiver 434 as well as achieve magnetic shielding. The power electronic devices may be integrated with magnetic couplers, enabling high compactness, modularity, and high power density. And of course, the proposed XFC design is scalable and extendable.

While the invention has been described with reference to the embodiments above, a person of ordinary skill in the art would understand that various changes or modifications may be made thereto without departing from the scope of the claims.

We claim:

1. A conductive fast charging system comprising:
an integrated power source including a power grid, a solar farm, and energy storage system,
fault protection connected to the integrated power source wherein the fault protection is based on multiple mutually coordinated solid-state DC circuit breakers; and
an off vehicle portable charger connected to the fault protection and coordinated therewith, wherein the off vehicle portable charger comprises at least one multiphase interleaved circuit that reduces the ripples of charging currents and filter size, wherein the interleaved circuit is in a modular hexagonal prism configuration that integrates power electronic devices with transformers.

2. The conductive fast charging system of claim 1, further comprising a central control that receives vehicle feedback when a vehicle is attached to the portable charger and real time information from the power source and based on these, monitors and controls the charging to the vehicle.

3. The conductive fast charging system of claim 2, wherein the central control assists voltage regulation, corrects power factors, and schedules reactive power demand for the conductive fast charging system.

4. The conductive fast charging system of claim 3, wherein the system further mitigates power outages.

5. The conductive fast charging system of claim 1, wherein multiphase transformers are distributed on side faces of the hexagonal prism and an input is connected inside the hexagonal prism.

6. The conductive fast charging system of claim 5, wherein a charger output is connected outside the hexagonal prism.

7. The conductive fast charging system of claim 1, wherein the charging system wirelessly charges vehicles.

8. A conductive fast charging system comprising:
an integrated power source including a power grid, a solar farm, and energy storage system,
fault protection connected to the integrated power source wherein the fault protection is based on multiple mutually coordinated solid-state DC circuit breakers; and
an off vehicle portable charger connected to the fault protection and coordinated therewith, wherein the off vehicle portable charger comprises at least one multiphase interleaved circuit that reduces the ripples of charging currents and filter size, wherein the interleaved circuit is in a modular hexagonal prism configuration that integrates power electronic devices with a coupled magnetic coupler.

9. The conductive fast charging system of claim 8, wherein an air gap between the transmitter and receiver of the magnetic coupler and an alternating magnetic field creates transfer power.

10. The conductive fast charging system of claim 8, further comprising a central control that received vehicle feedback when a vehicle is attached to the portable charger and real time information from the power source and based on these, monitors and controls the charging to the vehicle.

11. The conductive fast charging system of claim 10, wherein the central control assists voltage regulation, corrects power factors, and schedules reactive power demand for the conductive fast charging system.

12. The conductive fast charging system of claim 11, wherein the system further mitigates power outages.

13. The conductive fast charging system of claim 8, wherein multiphase transformers are distributed on side faces of the hexagonal prism and an input is connected inside the hexagonal prism.

14. The conductive fast charging system of claim 13, wherein a charger output is connected outside the hexagonal prism.

15. The conductive fast charging system of claim 8, wherein the charging system wirelessly charges vehicles.

16. A 500 kW conductive fast charger comprising:
a power source including a power grid with a solar farm and energy storage system, wherein the power source includes smart fault protection based on multiple mutually coordinated solid-state DC circuit breakers;
a multiphase interleaved circuit that reduces the ripples of charging currents and filter size, wherein the interleaved circuit is in a modular hexagonal prism configuration that integrates power electronic devices with transformers.
